(19) United States
(12) Patent Application Publication
(10) Pub. No.: US 2013/0175394 A1
(43) Pub. Date: Jul. 11, 2013

(54) ADJUSTABLE SPRING SYSTEM AND METHOD OF ADJUSTING SPRING RATE

(71) Applicant: Dale O. Cipra, Canoga Park, CA (US)

(72) Inventor: Dale O. Cipra, Canoga Park, CA (US)

(21) Appl. No.: 13/346,837

(22) Filed: Jan. 10, 2012

(51) Int. Cl. B64C 1/00; F16F 1/13; F16F 1/06

(52) U.S. Cl. 244/129.1; 267/166; 267/287

(57) ABSTRACT

An adjustable spring system includes an adjustment member adjustable relative to a coil spring to provide a desired number of unsupported coils. A method of adjusting the spring rate of the spring includes detecting a condition, and driving the adjustment member with an actuator in response to the detected condition. An effective length of the spring is changed with the adjustment member.

This invention was made with government support from the National Aeronautics and Space Administration under Contract No.: NNM06AB13C. The government may have certain rights to this invention pursuant to Contract No. NNM06AB13C awarded by the National Aeronautics and Space Administration.

### BACKGROUND

This disclosure relates to an adjustable spring system and a method of adjusting a spring rate in the system.

Adjustable coil springs have been used in coil-over type suspension systems. In one type of system, a shock absorber includes a body receiving a rod that is telescopically movable with respect to the body. The shock absorber is arranged between first and second members and damps the relative movement between the members.

In a coil-over arrangement, a coil spring is supported between an end of the rod and the body. In one example, a portion of the body has an annular groove that receives a portion of the coil spring. The body is positioned with respect to the coil spring to change the effective length of the coil spring and provide a desired spring rate.

### BRIEF DESCRIPTION OF THE DRAWINGS

The disclosure can be further understood by reference to the following detailed description when considered in connection with the accompanying drawings wherein:

FIG. 1 is a schematic view of an example adjustable spring system.

FIGS. 2A and 2B schematically illustrate a spring assembly of the adjustable spring system depicted in FIG. 1 in first and second positions.

FIG. 3 is a schematic view of one example application of the adjustable spring system.

FIGS. 4A-4C schematically depict an example adjustable spring system for the application illustrated in FIG. 3.

FIGS. 5A-5B schematically illustrate another application of the adjustable spring system.

### DETAILED DESCRIPTION

An adjustable spring system 10 is schematically illustrated in FIG. 1. The system 10 includes one or more spring assemblies 11 arranged between first and second members 12, 14 that are spaced apart from and movable relative to one another. The spring assemblies 11 provide an adjustable spring rate between the first and second members 12, 14.

Each spring assembly 11 includes a spring 16 having coils that cooperates with an adjustment member 18 that is drivable with respect to the spring 16 to change its spring rate by changing the length of the spring 16. The spring 16 and adjustment member 18 are coaxial with one another. An actuator 20 is operatively coupled to the adjustment member 18. A controller 22 communicates with the actuator 20 and a sensor 24 that detects a condition. In one example, the sensor 24 is an accelerometer, which may be used by the controller 22 to detect an undesired natural frequency of at least one of the first and second members 12, 14. In the example, a manual switch 26 is in communication with the actuator 20, either directly or indirectly, and is configured to be operable by a user to manually drive the adjustment member 18, as desired.

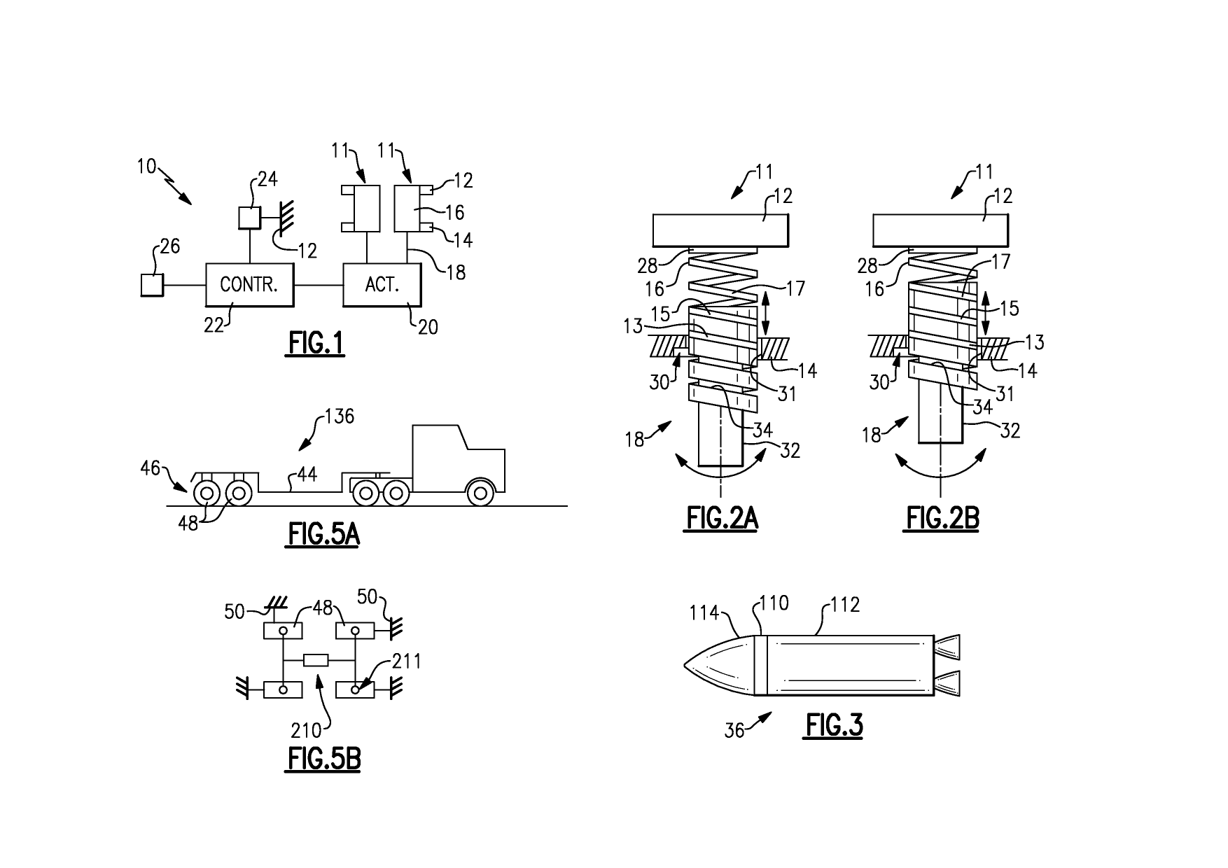

Referring to FIGS. 2A-2B, the input or adjustment member 18 includes a shaft 32 having a helical groove 34 on an outer surface, for example, receiving at least a portion of the spring 16. The shaft 32 may extend through an aperture 31 in the second member 14. First and second end portions 28, 30 of the spring 16 are respectively operatively secured to the first and second members 12, 14. In one example, the first and second end portions 28, 30 are affixed to the first and second members 12, 14. The spring assembly 11 shown in a first position in FIG. 2A provides a “softer” spring rate, while the second position shown in FIG. 2B provides a “stiffer” spring rate. The spring assembly 11 may provide virtually an infinite number of spring rate values within a range of spring rates.

The spring system 10 and its spring 16 includes multiple coils, such as first, second and third coils 13, 15, 17. A body, such as the adjustment member 18 mechanically supports the first and second coils 13, 15, as shown in FIG. 2A. The first and second coils helically adjoin one another. The adjustment member 18 is adjustable to mechanically support the third coil 17. The third coil 17 helically adjoins the second coil 15. In the example, the adjustment member 18 mechanically supports the spring 16 both torsionally and axially. The spring 16 may be a tension, torsion and/or compression spring.

The adjustment member 18 is rotatable relative to the spring 16 in the example to provide a desired number of unsupported coils, which corresponds to a desired spring rate. The shaft 32 is rotated in response to a command from the controller 22, for example, enabling the spring rate to be controlled in real time to react to various undesired conditions. In one example, an undesired natural frequency may be detected, and the controller 22 provides a command to the actuator 20 to provide a desired number of unsupported coils corresponding to a spring rate that negates the natural frequency of the first member 12. The sensor 24 provides feedback to as to the effectiveness of the adjustment made by the controller 22. In another example, a user may simply actuate the switch 26 to select a desired spring rate by feel, for example.

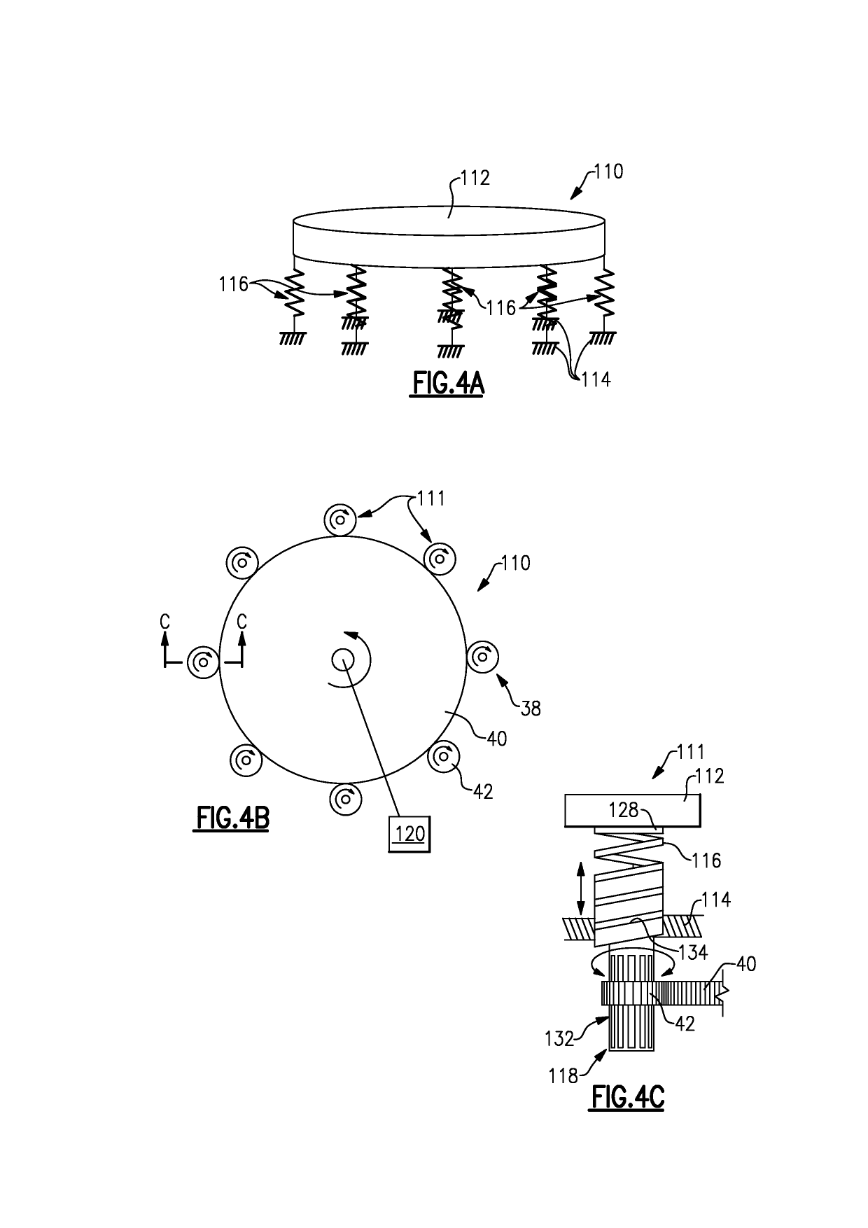

Referring to FIGS. 3-4C, one example application is a vehicle 36, such as a rocket. The vehicle 36 includes first and second portions 112, 114 that respectively correspond to a propulsion section and an occupant area. The adjustable spring system 110 is arranged between the first and second portions 112, 114. When an undesired natural frequency from the propulsion section exerts undesired loads on the occupant section, the adjustable spring system 110 changes the spring rate between the first and second portions 112, 114 to minimize the loads in the occupant area.

One example system 110 that may be used for the vehicle 36 is illustrated in FIGS. 4A-4C. Multiple springs 116 of corresponding spring assemblies 111 are arranged between the first and second portions 112, 114. To synchronize the spring assemblies 111, an epicyclic gear train 38 is used. The epicyclic gear train 38 includes a sun gear 40 operatively coupled to the actuator 120. Each spring assembly 111 includes a planetary gear 42 that meshes with the sun gear 40. As shown in FIG. 4C, the planetary gear 42 is connected to the adjustment member 118, which includes annular grooves 134 that receive a portion of the spring 116. In one example, the first end portion 128 is rotationally affixed to the first portion 112. In operation, the sun gear 40 is rotationally driven by the actuator 120 to drive the adjustment members 118 to achieve a desired spring rate in each of the springs 116.

Another application for a vehicle 136 is illustrated in FIGS. 5A-5B. The vehicle 136 includes a trailer 44 having a suspension system 46 that incorporates the adjustable spring system 210. The spring assemblies 211 are arranged between unsprung and sprung weights 48, 50. The adjustable spring system 210 may be adjusted automatically to address undesired natural frequencies or manually adjusted by the operator, as described above with respect to FIGS. 1-2B.

Although an example embodiment has been disclosed, a worker of ordinary skill in this art would recognize that certain modifications would come within the scope of the claims. For that reason, the following claims should be studied to determine their true scope and content.

What is claimed is:

1. An adjustable spring system comprising:
first and second members spaced apart from one another;
a spring assembly including
a coil spring having first and second end portions operative secured to the first and second members, respectively, and
an adjustment member supporting one of the first and second end portions and configured to be adjustable relative thereto to provide a desired number of unsupported coils; and
an actuator operatively coupled to the adjustment member and configured to position the adjustment member to provide the desired number of unsupported coils in response to a command.

2. The system according to claim 1, comprising a switch in communication with the actuator and configured to be operable by a user, the switch providing the command.

3. The system according to claim 1, comprising a controller in communication with the actuator, and a sensor in communication with the controller to detect a condition, the controller providing the command in response to the detected condition.

4. The system according to claim 3, wherein the sensor is an accelerometer.

5. The system according to claim 4, wherein the detected condition is a natural frequency of one of the first and second members.

6. The system according to claim 1, comprising multiple spring assemblies, the actuator coupled to multiple adjustment members.

7. The system according to claim 6, wherein the adjustment members include a shaft each having a groove cooperating with a corresponding coil spring.

8. The system according to claim 7, comprising an epicyclic gear train including a sun gear and planetary gears meshing with the sun gear, each planetary gear respectively coupled to a corresponding shaft.

9. The system according to claim 8, comprising a rocket including first and second portions respectively operatively coupled to a propulsion section and an occupant area, the first and second members respectively corresponding to the first and second portions.

10. The system according to claim 7, comprising a vehicle including a suspension having sprung and unsprung portions respectively corresponding to the first and second members.

11. The system according to claim 1, wherein the coil spring includes a number of coils between the first and second members, the number of coils unchanged throughout different positions of the adjustment member.

12. The system according to claim 11, wherein the first and second end portions are respectively fixed relative to the first and second members, respectively.

13. The system according to claim 1, wherein the desired number of unsupported coils corresponds to an effective spring length of the coil spring.

14. A method of adjusting a spring rate of a spring system comprising the steps of:
detecting a condition;
driving an adjustment member with an actuator in response to the detected condition; and
changing an effective length of a spring with the adjustment member.

15. The method according to claim 14, wherein the detected condition is a natural frequency.

16. An adjustable spring system comprising:
a plurality of coils;
a body mechanically supporting a first and a second of the plurality of coils, wherein the first and the second of the plurality of coils helically adjoining one another;
wherein the body is adjustable to mechanically support a third of the plurality of coils, wherein the third of the plurality of coils is helically adjacent the second of the plurality of coils.

17. The system according to claim 16, wherein the mechanically supporting is torsionally supporting.

18. The system according to claim 16, wherein the mechanically supporting is axially supporting.
